(19) United States
(12) Patent Application Publication
(10) Pub. No.: US 2025/0186883 A1
(43) Pub. Date: Jun. 12, 2025

(54) INTERACTION METHOD AND APPARATUS IN VIRTUAL SCENE, DEVICE, STORAGE MEDIUM, AND PRODUCT

(71) Applicant: Tencent Technology (Shenzhen) Company Limited, Shenzhen (CN)

(72) Inventor: Luxin ZHANG, Shenzhen (CN)

(21) Appl. No.: 19/057,510

(22) Filed: Feb. 19, 2025

Related U.S. Application Data
(63) Continuation of application No. PCT/CN2024/073185, filed on Jan. 19, 2024.

(30) Foreign Application Priority Data
Mar. 16, 2023 (CN) 202310289675.1

(51) Int. Cl. A63F 13/52

(52) U.S. Cl. CPC A63F 13/52

(57) ABSTRACT

An interaction method in a virtual scene is performed by a computer device. The method includes: displaying a virtual scene including a first virtual object and a second object, the first virtual object being a virtual object controlled by a user of the computer device; displaying SOS indication information when the first virtual object is in a restricted action state, the restricted action state being a state in which an action capability of the first virtual object is restricted in the virtual scene; displaying an SOS animation in response to receiving an SOS operation, the SOS animation being configured for representing that the first virtual object transmits a rescue request to the second virtual object; and displaying rescue indication information in response to that the second virtual object performs feedback to the rescue request.

### CROSS-REFERENCE TO RELATED APPLICATIONS

This application is a continuation application of PCT Patent Application No. PCT/CN2024/073185, entitled “INTERACTION METHOD AND APPARATUS IN VIRTUAL SCENE, DEVICE, STORAGE MEDIUM, AND PRODUCT” and filed on Jan. 19, 2024, which claims priority to Chinese Patent Application No. 202310289675.1, entitled “INTERACTION METHOD AND APPARATUS IN VIRTUAL SCENE, DEVICE, STORAGE MEDIUM, AND PRODUCT” and filed on Mar. 16, 2023, both of which are incorporated herein by reference in their entirety.

### FIELD OF THE TECHNOLOGY

This application relates to the field of virtual environment technologies, and in particular, to an interaction method and apparatus in a virtual scene, a device, a storage medium, and a product.

### BACKGROUND OF THE DISCLOSURE

In a fast-tempo virtual environment game, for a single-round multiplayer arena game that may consume team resources to revive after a player falls to the ground, it is very difficult to ensure that the player that falls to the ground can be quickly revived, and ensure that a friendly player having a rescue capability can have sufficient time and opportunity to complete a rescue experience.

In the related art, a teammate position is displayed in real time in a small map and a friendly player distance is displayed on a restricted-state player interface, and a friendly player status is transmitted to the player that falls to the ground.

However, rescue efficiency is low based on the foregoing method, resulting in a waste of rescue resources in a virtual battle. In a process in which a teammate moves to a player in a restricted action state, the player in the restricted action state chooses to give up the game. Consequently, an operation of the teammate is invalid, and efficiency of human-computer interaction is low.

### SUMMARY

Embodiments of this application provide an interaction method and apparatus in a virtual scene, a device, a storage medium, and a product. The technical solutions are as follows:

According to an aspect, an interaction method in a virtual scene is performed by a computer device. The method includes:
displaying a virtual scene including a first virtual object and a second object, the first virtual object being a virtual object controlled by a user of the computer device;
displaying SOS indication information when the first virtual object is in a restricted action state, the restricted action state being a state in which an action capability of the first virtual object is restricted in the virtual scene;
displaying an SOS animation in response to receiving an SOS operation, the SOS animation being configured for representing that the first virtual object transmits a rescue request to the second virtual object; and displaying rescue indication information in response to that the second virtual
object performs feedback to the rescue request, the rescue indication information being configured for indicating the second virtual object to accept the rescue request for rescuing the first virtual object.

According to another aspect, a computer device is provided. The computer device includes a processor and a memory, the memory having at least one instruction, at least one program, a code set or an instruction set stored therein, the at least one instruction, the at least one program, the code set or the instruction set being loaded and executed by the processor to cause the computer device to implement the interaction method in a virtual scene according to any one of the foregoing embodiments of this application.

According to another aspect, a non-transitory computer-readable storage medium is provided. The storage medium has at least one instruction, at least one program, a code set or an instruction set stored therein, the at least one instruction, the at least one program, the code set or the instruction set being loaded and executed by a processor of a computer device to cause the computer device implement the interaction method in a virtual scene according to any one of the foregoing embodiments of this application.

The technical solutions provided in the embodiments of this application include at least the following beneficial effects:

When the first virtual object is in the restricted action state, the SOS indication information is displayed, the SOS animation is displayed in response to receiving the SOS operation, and the rescue indication information is displayed in response to that the second virtual object performs feedback to the rescue request. The rescue willingness of the first virtual object is strengthened by using the SOS indication information, feedback is performed in time to the SOS operation of the first virtual character by using the SOS animation, and the first virtual object is notified of the rescue willingness of the second virtual object by using the rescue indication information, thereby implementing a feedback mechanism between SOS and rescue, enhancing willingness to wait for rescue, and improving rescue efficiency. Therefore, utilization of rescue resources is improved. This prevents a teammate virtual object from executing an invalid rescue operation, and improves efficiency of human-computer interaction of the teammate virtual object in providing rescue.

### BRIEF DESCRIPTION OF THE DRAWINGS

FIG. 1 is a schematic diagram of falling to ground and waiting for rescue according to an exemplary embodiment of this application.

FIG. 2 is a schematic diagram of an implementation environment according to an exemplary embodiment of this application.

FIG. 3 is a flowchart of an interaction method in a virtual scene according to an exemplary embodiment of this application.

FIG. 4 is a schematic diagram of an action restriction according to an exemplary embodiment of this application.

FIG. 5 is a schematic diagram of an SOS animation according to an exemplary embodiment of this application.

FIG. 6 is a schematic diagram of a rescue indicator line according to an exemplary embodiment of this application.

FIG. 7 is a flowchart of a method for giving up waiting for rescue according to an embodiment of this application.

FIG. 8 is a schematic diagram of rescue duration information according to an exemplary embodiment of this application.

FIG. 9 is a schematic diagram of giving up waiting for rescue according to an exemplary embodiment of this application.

FIG. 10 is a flowchart of an interaction method in a virtual scene according to another exemplary embodiment of this application.

FIG. 11 is a schematic diagram of rescue prompt information according to an exemplary embodiment of this application.

FIG. 12 is a schematic diagram of displaying a rescue request according to an exemplary embodiment of this application.

FIG. 13 is a schematic flowchart of an interface of a viewing angle of a player that falls to the ground and a viewing angle of a teammate player according to an exemplary embodiment of this application.

FIG. 14 is a structural block diagram of an interaction apparatus in a virtual scene according to an exemplary embodiment of this application.

FIG. 15 is a structural block diagram of an interaction apparatus module in a virtual scene according to an exemplary embodiment of this application.

FIG. 16 is a structural block diagram of an interaction apparatus in a virtual scene according to another exemplary embodiment of this application.

FIG. 17 is a structural block diagram of a terminal according to an exemplary embodiment of this application.

### DESCRIPTION OF EMBODIMENTS

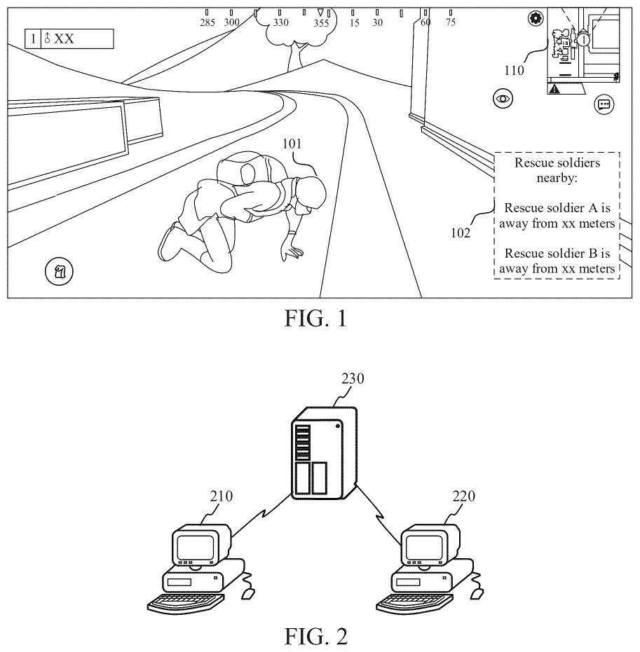

In the related art, a teammate position is displayed in real time in a small map and a friendly player distance is displayed on an interface of a player that falls to the ground, to send a friendly player status to the player that falls to the ground. For example, FIG. 1 is a schematic diagram of falling to ground and waiting for rescue according to an exemplary embodiment of this application. As shown in FIG. 1, a first virtual object 101 corresponding to the player that falls to the ground is displayed in a virtual scene, and a rescue distance list 102 is displayed in the virtual scene in response to that the first virtual object 101 falls to the ground. The rescue list 102 includes a distance between a virtual object corresponding to a teammate of the player that falls to the ground and the first virtual object 101, a small map 110 is further displayed in the virtual scene, and a position identifier of the teammate of the player that falls to the ground within a map display range is displayed in the small map 110. However, in the foregoing method, the player that falls to the ground cannot learn a friendly player rescue willingness in time, leading to a high probability of giving up waiting for rescue and low rescue efficiency.

According to the method provided in the embodiments of this application, when the first virtual object is in a restricted action state, SOS indication information is displayed, an SOS animation is displayed in response to receiving an SOS operation, and rescue indication information is displayed in response to that a second virtual object performs feedback to a rescue request. Rescue willingness of the first virtual object is strengthened by using the SOS indication information, feedback is performed in time to the SOS operation of the first virtual character by using the SOS animation, and the first virtual object is notified of rescue willingness of the second virtual object by using the rescue indication information, thereby implementing a feedback mechanism between SOS and rescue, enhancing willingness to wait for rescue, and improving rescue efficiency.

First, an implementation environment in this application is introduced. FIG. 2 is a schematic diagram of an implementation environment according to an exemplary embodiment of this application. The implementation environment includes: a terminal 210, a terminal 220, and a server 230.

The terminal 210 and the terminal 220 are installed with an application that can provide a game battle scene. The application may be implemented as a game application, a training simulation application, a social application, a multimedia application, or the like. This is not restricted in this embodiment of this application.

In some embodiments, a player account corresponding to the first virtual object is logged into on the terminal 210, and is configured to mainly control an activity of the first virtual object in the virtual scene, and a player account corresponding to the second virtual object is logged into on the terminal 220, and is configured to mainly control an activity of the second virtual object in the virtual scene. An interaction operation such as SOS and rescue may be performed between the first virtual object and the second virtual object. In some embodiments, there may be an association relationship between the first virtual object and the second virtual object. For example: a friend relationship or a relationship of being in the same team group. Alternatively, there may be a stranger relationship between the first virtual object and the second virtual object.

The server 230 is configured to interact or transfer communication messages between accounts. In some embodiments, the server 230 is further configured to send scene construction data of the game battle scene to the terminal, so that the game battle scene is rendered and displayed in the terminal.

In this embodiment of this application, an example in which the first virtual object gives SOS to the second virtual object is used for description. The terminal 210 displays the first virtual object in the virtual scene, and displays SOS indication information when the first virtual object is in a restricted action state, where the SOS indication information is configured for indicating the first virtual object to initiate a rescue request. In some embodiments, the SOS indication information may be displayed in a form of an SOS control, a rescue map, or the like. The restricted action state is a state in which an action capability of the first virtual object is restricted in the virtual scene, for example, in a state such as being injured, falling to ground, or stuck in a trap. In some embodiments, the restricted action state is a state caused by that an object attribute value of the first virtual object decreases. For example, after the first virtual object is attacked, and a health point decreases to a threshold, the action capability of the first virtual object is restricted, switches to a falling-to-ground state, and cannot perform movement such as attacking or running. In some other embodiments, the restricted action state is caused by a position of the first virtual object in the virtual scene. For example, the first virtual object is in a swamp in the virtual scene, limiting action capability of the first virtual object.

An SOS animation is displayed in response to receiving an SOS operation, the SOS animation being configured for representing that the first virtual object transmits a rescue request to the second virtual object, and rescue indication information is displayed in response to that the second virtual object performs feedback to the rescue request, the rescue indication information being configured for indicating the second virtual object to accept the rescue request for rescuing the first virtual object. In some embodiments, the server 230 receives the SOS operation of the first virtual object, sends rendering data of the SOS animation to the terminal 210, and the terminal 210 renders and displays the rendering data, and sends the rescue request to the terminal 220. When the server 230 receives feedback from the terminal 220 for the rescue request, the server 230 sends the rescue indication information or feedback information to the terminal 210, and the terminal 210 displays the received rescue indication information, or generates and displays the rescue indication information based on the received feedback information.

The foregoing terminal may be exemplary. The terminal may be terminal devices in a plurality of forms such as a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, a smart television, and a smart vehicle. This is not limited in this embodiment of this application.

The foregoing server may be an independent physical server, or may be a server cluster or a distributed system formed by a plurality of physical servers, or may be a cloud server that provides basic cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

In some embodiments, the foregoing server may alternatively be implemented as a node in a blockchain system.

The information (including, but is not limited to, user equipment information, user personal information, and the like), data (including, but is not limited to, data for analysis, stored data, displayed data, and the like), and signals involved in this application all are authorized by a user or fully authorized by each party, and the collection, use, and processing of relevant data need to comply with relevant laws, regulations, and standards of relevant countries and regions.

With reference to the foregoing noun introduction and implementation environment, an application scenario of the interaction method in the virtual scene provided in the embodiments of this application is described.

### 1. Applied to the Game Application

In some embodiments, in the game application, a user participates in a game process by controlling actions of the first virtual object. The user may control the first virtual object to enter a virtual battle scenario in the game for a battle. In some embodiments, when the first virtual object is in the restricted action state such as falling to ground, being injured, or being trapped, the SOS indication information is displayed; an SOS animation configured for representing that the first virtual object transmits the rescue request to the second virtual object is displayed in response to receiving the SOS operation; and the rescue indication information configured for indicating the second virtual object to accept the rescue request for rescuing the first virtual object is displayed in response to that the second virtual object performs feedback to the rescue request.

### 2. Applied to a Training Simulation Scenario

In some embodiments, in an extended reality (XR) scenario, training simulation may be performed in real space by wearing an XR device. For example, a medical rescue maneuver is performed by wearing the XR device, and a user of the XR device substitutes the first virtual character at a first viewing angle, or a first virtual character in a display range of the device is controlled, and the first virtual character is displayed in reality space, to implement a scenario of virtual training simulation in the reality space. In some embodiments, when the first virtual object is in the restricted action state such as falling to ground or being injured, the SOS indication information is displayed; the SOS animation configured for representing that the first virtual object transmits the rescue request to the second virtual object is displayed in response to receiving the SOS operation; and the rescue indication information configured for indicating the second virtual object to accept the rescue request for the first virtual object is displayed in response to that the second virtual object performs feedback to the rescue request.

The foregoing application scenarios are merely illustrative examples. The interaction method in a virtual scene provided in the embodiments of this application may be used in any virtual scene in which a rescue interaction requirement exists, and this is not limited in this application.

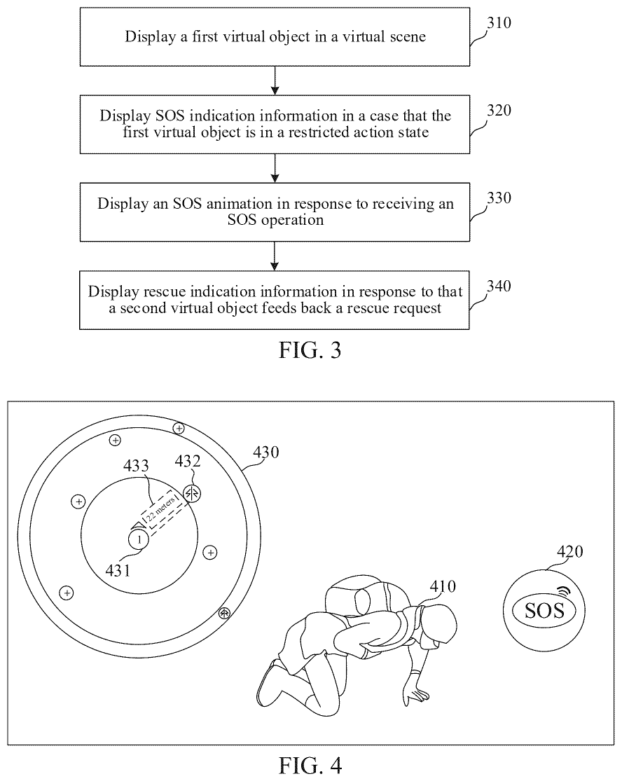

For example, FIG. 3 is a flowchart of an interaction method in a virtual scene according to an exemplary embodiment of this application. The method is performed by a computer device, where the method may be performed by a terminal, a server, or a terminal and a server in cooperation. In this embodiment of this application, an example in which the method is performed by the terminal is used for description. As shown in FIG. 3, the method includes the following operations:

Operation 310: Display a first virtual object in a virtual scene.

The first virtual object is a virtual object mainly controlled by a current terminal, and the virtual scene further includes a second virtual object.

In some embodiments, the first virtual object may be a single virtual character mainly controlled by the current terminal, for example, a virtual character in a shooting game, or may be a plurality of virtual characters mainly controlled by the current terminal, for example, a queue formed by the plurality of virtual characters in the same camp in a tower defense game. In some embodiments, a display manner of the first virtual object includes displaying a picture within a viewing angle range of the first virtual character at the first viewing angle, or displaying a picture including the first virtual character at a third viewing angle. This is not restricted in this application.

In some embodiments, the second virtual object may be a virtual object having an association relationship with the first virtual object, for example, a friend relationship or a relationship of being in a team, or may be a virtual object having a stranger relationship with the first virtual object, for example, a virtual object randomly matched to the same battle.

Operation 320: Display SOS indication information when the first virtual object is in a restricted action state.

The SOS indication information is configured for indicating the first virtual object to initiate a rescue request, and the restricted action state is a state in which an action capability of the first virtual object is restricted in the virtual scene.

In some embodiments, the restricted action state refers to a state in which the first virtual object cannot move fast or has a restricted movement range, that is, a state in which the first virtual object cannot move at a specified movement speed. When the first virtual object is in the restricted action state, the first virtual object needs to wait for rescue to release the restricted action state, to restore the action capability. In some embodiments, the restricted action state may be a preset restricted action capability state such as the first virtual object being injured, falling to ground, or stuck in a trap. For example, in a game combat scene, when the first virtual object is hit, and a current health point of the first virtual object is lower than a health point threshold, the first virtual object falls to the ground, that is, the first virtual object is in the restricted action state. Alternatively, in the training simulation scenario, when the first virtual object steps on a virtual trap, the first virtual object is stuck in a position in which the virtual trap is located, and cannot move, that is, the first virtual object is in the restricted action state.

In some embodiments, the SOS indication information may be implemented as information such as SOS indication guidance, an SOS control, or a rescue map that is configured for indicating the first virtual object to initiate the rescue request. For example, the SOS indication guidance is displayed in a form of a pop-up window or a banner, to guide the first virtual object to perform SOS by using a specified SOS operation, for example, trigger the SOS control, move the first virtual object to an SOS point, or send SOS information. The SOS control indicates the first virtual object to initiate the rescue request by triggering the SOS control. The rescue map is configured for displaying a position relationship between the second virtual object that can receive the rescue request and the first virtual object.

The SOS indication information is displayed to prompt a player to trigger the SOS operation to perform SOS, and an intuitive SOS prompt is provided for the player, to prevent the player from giving up the game in a case in which the player does not understand an SOS function. Consequently, teammate rescue fails, resulting in low efficiency of human-computer interaction.

In some embodiments, the rescue indication information includes at least one of the following: an SOS control, configured to receive an SOS operation; an SOS-capable object identifier, configured for indicating a second virtual object conforming to a rescue condition; and a minimum rescue distance, configured for indicating a minimum distance between a plurality of second virtual objects conforming to the rescue condition and the first virtual object, where the rescue condition includes that a distance between the second virtual object and the first virtual object is less than a rescue distance threshold, or the second virtual object and the first virtual object are in the same camp, or the second virtual object conforms to a specified virtual character identity, for example, a character identity of an emergency solider having a rescue function.

A control for triggering the SOS operation is provided on an interface by displaying the SOS control, so that an interface element for triggering the SOS operation can be intuitively presented to the player, thereby improving human-computer interaction efficiency and speed of triggering the SOS operation.

The second virtual object that can rescue the first virtual object is presented to the player by displaying the SOS-capable object identifier, so that the player intuitively learns a possibility that the first virtual object can be rescued, to determine whether to continue the game. If there is no second virtual object that can rescue the first virtual object, the game directly ends, thereby saving computing resources of the game, and saving resource overheads of the server.

A distance that the second virtual object needs to travel to rescue the first virtual object is presented to the player by displaying the minimum rescue distance, thereby improving an amount of information displayed on the interface.

For example, FIG. 4 is a schematic diagram of an action restriction according to an exemplary embodiment of this application. As shown in FIG. 4, a first virtual object 410 is in a restricted action state, SOS indication information is displayed, and includes an SOS control 420 and a rescue map 430. The SOS control 420 is configured to receive an SOS operation. The rescue map 430 includes a first positioning identifier 431 corresponding to the first virtual object, a second positioning identifier 432 corresponding to a second virtual object, and a distance 433 between the second virtual object and the first virtual object.

Operation 330: Display an SOS animation in response to receiving an SOS operation.

The SOS animation is configured for representing that the first virtual object transmits the rescue request to the second virtual object.

In some embodiments, the SOS operation includes at least one of the following: A trigger operation on the SOS control, for example, clicking on or long-pressing the SOS control, a control operation conforming to an SOS requirement, for example, a movement operation of moving the first virtual object to an SOS point, or a sending operation on SOS information, for example, triggering an SOS shortcut message.

The SOS operation is triggered for the SOS control, and the SOS control provided by the interface is configured to quickly send the rescue request to the second virtual object, thereby improving efficiency of human-computer interaction, and improving speed of triggering the sending of the rescue request.

The sending of the rescue request is triggered by using the control operation. When there are a plurality of first virtual objects under control of a main control account, and there is one first virtual object that needs rescue, the first virtual object that needs rescue is moved to the SOS point, the first virtual object that needs rescue is clarified, and the second virtual object is prevented from moving to a position of another virtual object, thereby improving the efficiency of human-computer interaction.

The rescue request is sent by using the sending operation on the SOS information. When the player sends the SOS information, the sending of the rescue request is triggered, so that sending of the SOS information and the rescue request are simultaneously achieved, to avoid that sending of the rescue request further needs to be additionally performed when the player has a requirement of sending the SOS information, thereby improving the efficiency of human-computer interaction, and reducing overheads of operations of sending the SOS information and the rescue request.

In some embodiments, a virtual map is further superimposed on a display picture, configured for indicating a position of the first virtual object in the virtual scene. In some embodiments, the virtual map may be implemented as a map thumbnail picture of a virtual scene region in which the first virtual object is located. That is, the virtual map is a map picture in which a virtual scene map is zoomed out according to a specified proportion and displays the region in which the first virtual object is located.

In some embodiments, operation 330 includes the following operations.

Operation 1: Transmit the rescue request to the second virtual object in response to receiving the SOS operation.

In some embodiments, based on the rescue request, rescue request information corresponding to the rescue request is displayed on a terminal interface corresponding to the second virtual object, to notify the second virtual object of the rescue request of the first virtual object. In some embodiments, the rescue request information may be implemented as rescue shortcut information, or rescue prompt information including an identity and position information of the first virtual object. For example, rescue shortcut information whose content is “Your teammate A is calling you for help 20 meters away” is displayed on the terminal interface corresponding to the second virtual object as the rescue request information. Alternatively, rescue prompt information including an avatar frame corresponding to the first virtual object and the distance between the first virtual object and the second virtual object is displayed on the terminal interface corresponding to the second virtual object, and the second virtual object may return the rescue request of the first virtual object by triggering the rescue prompt information.

The rescue request information corresponding to the rescue request is displayed on the interface, to intuitively indicate to the player that a first virtual object that needs rescue exists, and the rescue request information is used as a shortcut control, to provide the player with a rescue feedback by using the rescue request information, thereby improving efficiency of interaction between the first virtual object and the second virtual object.

Operation 2: Display the SOS animation in a virtual map.

The virtual map includes the first positioning identifier corresponding to the first virtual object, and the second positioning identifier corresponding to the second virtual object. The first positioning identifier and the second positioning identifier are configured for indicating a position relationship between the first virtual object and the second virtual object.

In some embodiments, the SOS animation is implemented as an animation displayed in the virtual map. In some embodiments, the SOS animation includes an animation in which the first positioning identifier sends the rescue request to the second positioning identifier. In some embodiments, an animation effect of diffusing from a first arc to a second arc is displayed in the virtual map in response to receiving the SOS operation, the first arc and the second arc being arches using the first positioning identifier as a center, and a radius of the first arc being less than a radius of the second arc.

A diffusion animation effect between the first arc and the second arc is used as the SOS animation in the virtual map, to highlight and display that the first virtual object represented by the first positioning identifier sends the SOS request to the second virtual object represented by the second positioning identifier. In this way, an SOS process is displayed, to improve efficiency of displaying the interface.

In some embodiments, when the second positioning identifier and the second arc conform to the position relationship, a request delivery identifier corresponding to the second positioning identifier is displayed in the virtual map, and the request delivery identifier is configured for representing that the rescue request is displayed to the second virtual object. In some embodiments, the foregoing position relationship includes any preset position relationship such as that the second positioning identifier is inside the second arc, the second positioning identifier is on the second arc, or the second positioning identifier is outside the second arc within a specified distance range.

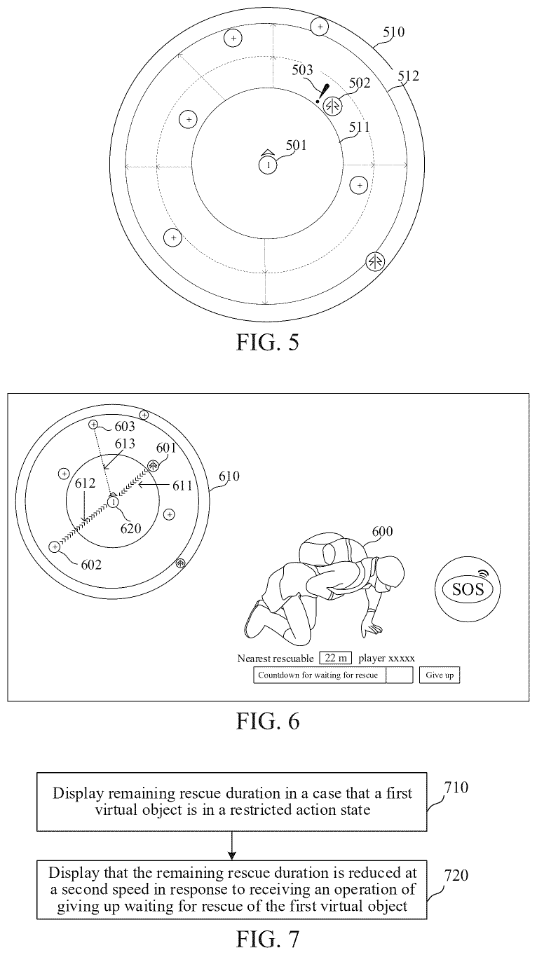

For example, FIG. 5 is a schematic diagram of an SOS animation according to an exemplary embodiment of this application. As shown in FIG. 5, an animation effect of diffusing from a first arc 511 to a second arc 512 is displayed in a virtual map 510. The first arc 511 and the second arc 512 are arcs using the first positioning identifier 501 as a center, and a radius of the first arc is less than a radius of the second arc. When the second positioning identifier 502 is inside the second arc 512, that is, the second positioning identifier 502 and the second arc 512 conform to the position relationship, a request delivery identifier 503 corresponding to the second positioning identifier 502 is displayed in the virtual map 510.

Operation 340: Display rescue indication information in response to that a second virtual object performs feedback to a rescue request.

The rescue indication information is configured for indicating the second virtual object to accept the rescue request for rescuing the first virtual object.

In some embodiments, the second virtual object is a virtual object that receives the rescue request and accepts the rescue request. In some embodiments, the distance between the second virtual object and the first virtual object is less than a rescue distance threshold, or the second virtual object and the first virtual object are in the same camp, or the second virtual object has the rescue function, or the second virtual object holds a rescue prop, or the like.

When the distance between the second virtual object and the first virtual object is less than the rescue distance threshold, in response to a rescue feedback of the second virtual object, it is ensured that the second virtual object meeting a rescue distance requirement provides rescue to the first virtual object, to prevent the second virtual object that is far away from moving to the first virtual object because the second virtual object cannot effectively provide rescue, resulting in a rescue failure, and the second virtual object wastes time resources, physical resources, and the like consumed by moving, thereby improving interaction efficiency.

When the second virtual object and the first virtual object are in the same camp, in response to the rescue feedback of the second virtual object, it is avoided that rescue is rejected to be provided to the first virtual object after a virtual object in a different camp from the first virtual object is mistouched or the rescue feedback is provided. As a result, rescue efficiency is low, and a player experience is poor.

When the second virtual object has the rescue function or holds the rescue prop, in response to the rescue feedback of the second virtual object, it is avoided a problem that the second virtual object that does not have the rescue function or does not hold the rescue prop cannot provide actual rescue after responding to the rescue feedback, resulting in low rescue efficiency and poor player experience.

In some embodiments, the rescue indication information includes at least one of the following: an identity of the second virtual object; a rescue distance, configured for indicating a distance between the second virtual object and the first virtual object in the virtual scene; rescue duration, configured for indicating duration required by the second virtual object to reach a position of the first virtual object at a specified speed; or a rescue indicator line, configured for representing a degree of willingness tendency of the second virtual object to rescue the first virtual object.

An example in which the rescue indication information includes the rescue indicator line is used for description. The displaying rescue indication information in response to that a second virtual object performs feedback to a rescue request includes the following three cases:
Case 1: A first rescue indicator line connected between the first positioning identifier and the second positioning identifier is displayed in the virtual map in response to that the second virtual object accepts the rescue request.
Case 2: The first rescue indicator line is displayed in the virtual map in response to that the second virtual object calibrates the first positioning identifier in the virtual map.
Case 3: A second rescue indicator line connected between the first positioning identifier and the second positioning identifier is displayed in the virtual map in response to that the second virtual object moves to the first virtual object at a movement speed exceeding a speed threshold.

A display priority of the first rescue indicator line is higher than a display priority of the second rescue indicator line. In some embodiments, the display priority is configured for indicating a manner of displaying the rescue indication information when a plurality of rescue indication information display situations simultaneously exist. For example, when the second virtual object moves to the first virtual object at the movement speed exceeding the speed threshold, the second virtual object accepts the rescue request, or the second virtual object calibrates the first positioning identifier in the virtual map. In this case, the display priority of the first rescue indicator line is higher than the display priority of the second rescue indicator line, and the first rescue indicator line is displayed, that is, the second virtual object represented by the first rescue indicator line has stronger rescue willingness to rescue the first virtual object than that represented by the second rescue indicator line.

For example, FIG. 6 is a schematic diagram of a rescue indicator line according to an exemplary embodiment of this application. As shown in FIG. 6, in response to that a virtual object A accepts a rescue request, a first rescue indicator line 611 connected between a first positioning identifier 620 and a second positioning identifier 601 is displayed in a virtual map 610. In response to that a virtual object B calibrates the first positioning identifier 620 in the virtual map 610, a first rescue indicator line 612 connected between the first positioning identifier 620 and the second positioning identifier 602 is displayed in the virtual map 610. In response to that a virtual object C moves to a first virtual object 600 at the movement speed exceeding the speed threshold, a second rescue indicator line 613 connected between the first positioning identifier 620 and the second positioning identifier 603 is displayed in the virtual map 610.

In summary, according to the method provided in this embodiment of this application, when the first virtual object is in the restricted action state, the SOS indication information is displayed, the SOS animation is displayed in response to receiving the SOS operation, and the rescue indication information is displayed in response to that the second virtual object performs feedback to the rescue request. The rescue willingness of the first virtual object is strengthened by using the SOS indication information, feedback is performed in time to the SOS operation of the first virtual character by using the SOS animation, and the first virtual object is notified of the rescue willingness of the second virtual object by using the rescue indication information, thereby implementing a feedback mechanism between SOS and rescue, enhancing willingness to wait for rescue, and improving rescue efficiency. Therefore, utilization of rescue resources is improved.

In the method provided in the embodiments of this application, the rescue request is transmitted to the second virtual object in response to receiving the SOS operation, and the SOS animation is displayed in the virtual map, so that dynamic effect feedback is implemented, and SOS is successfully fed back to the first virtual object.

According to the method provided in the embodiments of this application, the request delivery identifier corresponding to the second positioning identifier is displayed in the virtual map when the second positioning identifier and the second arc conform to the position relationship, and the request delivery identifier is configured for representing that the rescue request is displayed to the second virtual object, thereby implementing dynamic effect feedback, and feeding back a reception situation of the rescue request to the first virtual object.

The method provided in the embodiments of this application provides a method for displaying rescue indication information. In response to that the second virtual object accepts the rescue request, the first rescue indicator line connected between the first positioning identifier and the second positioning identifier is displayed in the virtual map; or the first rescue indicator line is displayed in the virtual map in response to that the second virtual object calibrates the first positioning identifier in the virtual map; or the second rescue indicator line connected between the first positioning identifier and the second positioning identifier is displayed in the virtual map in response to that the second virtual object moves to the first virtual object at the movement speed exceeding the speed threshold, where the display priority of the first rescue indicator line is higher than the display priority of the second rescue indicator line. The rescue willingness of the second virtual object is fed back to the first virtual object by using the rescue indicator line, and different rescue indicator lines are displayed based on different feedback situations of the second virtual object for the rescue request. A degree of rescue willingness of the second virtual object is differently fed back for the first virtual object, to help the first virtual object determine whether it is necessary to wait for rescue, which improves rescue efficiency.

FIG. 7 is a flowchart of a method for giving up waiting for rescue according to an exemplary embodiment of this application. The method is performed by a computer device, where the method may be performed by a terminal, a server, or a terminal and a server in cooperation. In this embodiment of this application, an example in which the method is performed by the terminal is used for description. As shown in FIG. 7, the method includes the following steps:

Operation 710: Display remaining rescue duration when a first virtual object is in a restricted action state.

The remaining rescue duration is configured for indicating remaining duration for which the first virtual object can perform rescue by using the second virtual object to release the restricted action state, and the remaining rescue duration is reduced at a first speed.

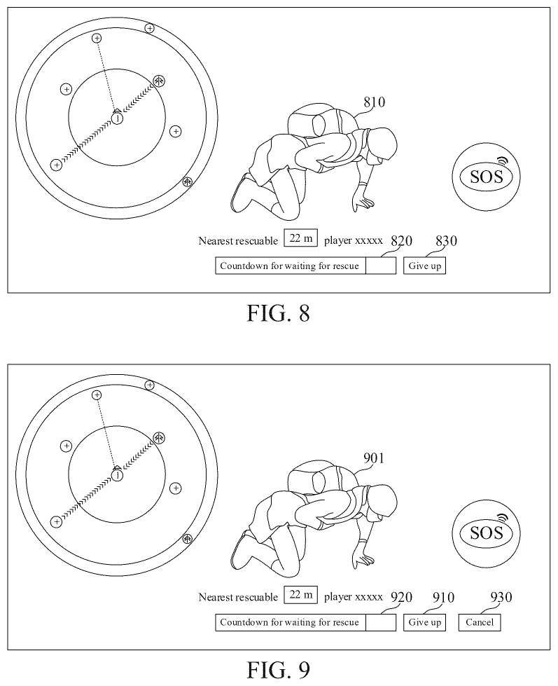

For example, FIG. 8 is a schematic diagram of remaining rescue duration according to an exemplary embodiment of this application. As shown in FIG. 8, when a first virtual object 810 is in a restricted action state, a countdown progress bar 820 of the remaining rescue duration is displayed, the remaining rescue duration indicated by the countdown progress bar 820 decreases at a first speed, a giving up control 830 is displayed, and the giving up control 830 is configured to receive an operation of giving up waiting for rescue.

Operation 720: Display that the remaining rescue duration is reduced at a second speed in response to receiving an operation of giving up waiting for rescue from the first virtual object.

The operation of giving up waiting for rescue is configured for giving up waiting for rescue, and the second speed is greater than the first speed.

In some embodiments, the operation of giving up waiting for rescue includes a giving up operation such as triggering a giving up control, moving the first virtual object to a point of giving up waiting for rescue, or sending information about giving up waiting for rescue.

For example, FIG. 9 is a schematic diagram of giving up waiting for rescue according to an exemplary embodiment of this application. As shown in FIG. 9, in response to a trigger operation on a giving up control 910, a first virtual object 901 gives up waiting for rescue, a countdown progress bar 920 of remaining rescue duration is reduced at a second speed, and a cancellation control 930 is displayed. The cancellation control 930 is configured to cancel giving up waiting for rescue.

In some embodiments, when the first virtual object gives up waiting for rescue, the first virtual object may cancel giving up waiting for rescue. In some embodiments, an implementation in which the first virtual object cancels giving up waiting for rescue includes a cancellation operation such as triggering a cancellation control or moving the first virtual object to a point of canceling giving up waiting for rescue. In some embodiments, in response to receiving an operation of canceling giving up waiting for rescue from the first virtual object, the remaining duration indicated by the rescue duration information is restored to be reduced at the first speed.

In summary, according to the method provided in this embodiment of this application, when a first virtual object is in a restricted action state, remaining rescue duration is displayed, where the remaining rescue duration is configured for indicating remaining duration for which the first virtual object can perform rescue by using a second virtual object to release the restricted action state, and the remaining rescue duration is reduced at a first speed, so that the first virtual object can learn, in real time, whether the first virtual object can wait for until being rescued. In response to that the first virtual object gives up waiting for rescue, the remaining duration indicated by rescue duration information is reduced at a second speed, where the second speed is greater than the first speed. The sense of urgency that the first virtual object is about to being out of game when giving up waiting for rescue is enhanced, and a probability that the first virtual object waits for rescue is increased, thereby improving rescue efficiency.

According to the method provided in the embodiments of this application, a method for canceling giving up waiting for rescue is provided. In response to receiving an operation of canceling giving up waiting for rescue from the first virtual object, the remaining rescue duration is restored to be reduced at the first speed, to provide the first virtual object with an opportunity to regret giving up waiting for rescue, thereby improving a probability of waiting for rescue and successfully being rescued.

In some embodiments, to reduce a tendency of the first virtual object to give up waiting for rescue, and improve the probability of waiting for rescue and the rescue efficiency, when the operation of giving up waiting for rescue from the first virtual object is received, the following two cases are included:
Case 1: When the rescue duration is less than the remaining rescue duration, in response to receiving the operation of giving up waiting for rescue from the first virtual object, the rescue prompt information is displayed.

The rescue prompt information is configured for prompting the first virtual object that the rescue duration is less than the remaining rescue duration, and confirming that the first virtual object gives up waiting for rescue. In other words, the rescue prompt information is configured for emphasizing, to the first virtual object, that the first virtual object can be successfully rescued, the rescue duration is configured for indicating duration for which the second virtual object reaches the position of the first virtual object at the specified speed, and the remaining rescue duration is duration for which the first virtual object can release, by being rescued, the restricted action state.

The rescue prompt information is displayed, to indicate, to a player corresponding to the first virtual object, a possibility of being rescued by the second virtual object, to avoid a case in which the player infers that he/she is not fallen within a possible range of rescue and gives up being rescued when he/she can be rescued, thereby improving the rescue efficiency.

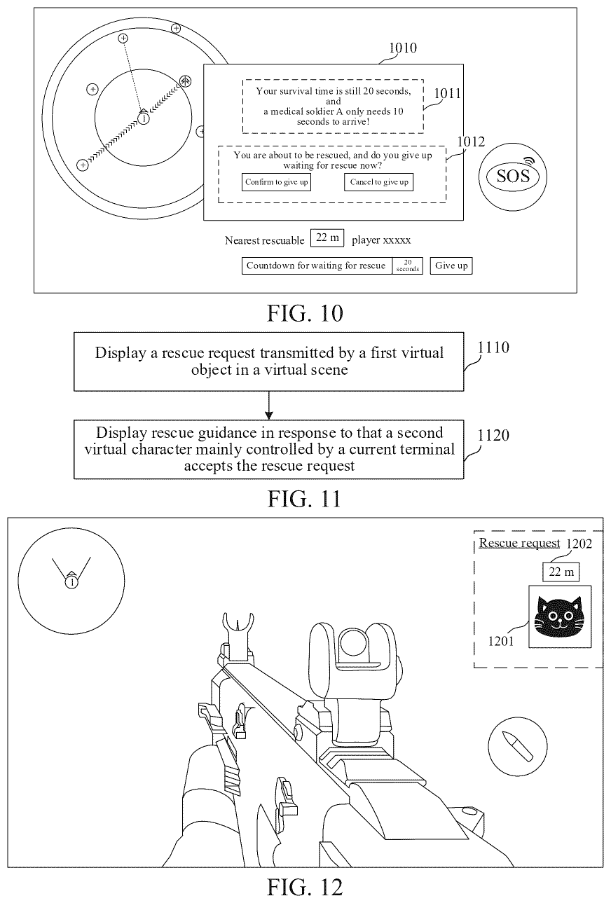

For example, FIG. 10 is a schematic diagram of rescue prompt information according to an exemplary embodiment of this application. As shown in FIG. 10, when rescue duration 10 seconds is less than remaining rescue duration 20 seconds, in response to receiving an operation of giving up waiting for rescue from a first virtual object, rescue prompt information 1010 is displayed, including duration information 1011 and giving up confirmation information 1012.
Case 2: In response to receiving the operation of giving up waiting for rescue, an out-of-game preview animation is played.

The out-of-game preview animation includes an animation in which the first virtual object switches from the restricted action state to an out-of-game state, and the out-of-game state is a state in which the first virtual object ends a battle on the first virtual object. In some embodiments, the out-of-game state is a state corresponding to the first virtual object when the remaining rescue duration is zero.

In some embodiments, the out-of-game state includes that the first virtual object exits a battle in this round, or the first virtual object deducts a health point or another resource to rejoin a battle in this round in a revival state, or the first virtual object enters a viewing mode, or the first virtual object remains in a current virtual scene in a form that does not affect a current battle round. The foregoing out-of-game state is merely an exemplary example. This is not limited in this application.

In summary, the method provided in this embodiment of this application provides two cases in which rescue prompt information is displayed or an out-of-game preview animation is played when an operation of giving up waiting for rescue from a first virtual object is received, to reduce a tendency of the first virtual object to give up waiting for rescue, thereby improving a probability of waiting for rescue and rescue efficiency.

In some embodiments, to enhance a feedback effect of the rescue request, and improve willingness of the first virtual object to wait for rescue, a case in which the rescue animation achieves the foregoing objective includes at least one of the following:
Case 1: In response to that the second virtual object performs feedback to the rescue request, an animation in which the second virtual object moves to the first virtual object is played.

In some embodiments, Cases in which the second virtual object performs feedback to the rescue request include that the second virtual object accepts the rescue request, the second virtual object calibrates, in the virtual map, the first positioning identifier corresponding to the first virtual object, or the like.
Case 2: In response to that the second virtual object conforms to a rescue success condition, an animation in which the second virtual object moves to the first virtual object is displayed.

In some embodiments, an animation in which the second virtual object moves to the first virtual object is displayed and played at a specified position in a form of a small window. In some embodiments, the animation may be a moving picture corresponding to a viewing angle of the second virtual object when the second virtual object moves to the first virtual object, or may be a thumbnail animation in which the second virtual object moves to the first virtual object under a global viewing angle.
Case 3: In response to that the second virtual object conforms to the rescue success condition, a rescue success preview animation is displayed.

The rescue success preview animation includes an animation in which the first virtual object switches from the restricted action state to a normal action state, and the normal action state is a state in which the action capability of the first virtual object is not restricted in the virtual scene.

In some embodiments, the foregoing rescue success condition includes that the rescue distance is less than a distance threshold, or the rescue duration is less than a duration threshold. The rescue distance is configured for indicating the distance between the second virtual object and the first virtual object in the virtual scene, and the rescue duration is configured for indicating the duration required by the second virtual object to reach the position of the first virtual object at the specified speed.

In summary, according to the method provided in this embodiment of this application, three manners of displaying the rescue animation are provided, to enhance the feedback effect of the rescue request, and improve the willingness of the first virtual object to wait for rescue.

FIG. 11 is a flowchart of an interaction method in a virtual scene according to an exemplary embodiment of this application. The method is performed by a computer device, where the method may be performed by a terminal, a server, or a terminal and a server in cooperation. In this embodiment of this application, an example in which the method is performed by the terminal is used for description. As shown in FIG. 11, the method includes the following operations:

Operation 1110: Display a rescue request transmitted by a first virtual object in a virtual scene.

A rescue request is a request transmitted by a first virtual object by using an SOS operation when the first virtual object is in a restricted action state. The rescue request includes an identity and position information of the first virtual object, and the restricted action state is a state in which an action capability of the first virtual object is restricted in a virtual scene.

In some embodiments, the first virtual object and the second virtual object mainly controlled by the current terminal conform to a rescue relationship. In some embodiments, the rescue relationship includes at least one of the following:
Case 1: A distance between the first virtual object and the second virtual object is less than a rescue distance threshold.
Case 2: The first virtual object and the second virtual object are in the same camp.
Case 3: The first virtual object is in a specified SOS position.
Case 4: The first virtual object is in a restricted action state, and the second virtual object has a rescue function or holds a rescue prop.

The foregoing rescue relationship is merely an exemplary example. This is not limited in this application.

In some embodiments, the rescue request is displayed in a form of a pop-up window, the identity of the first virtual object in the rescue request is implemented as an avatar frame of the first virtual object, and the position information of the first virtual object is implemented as the distance between the first virtual object and the second virtual object. For example, FIG. 12 is a schematic diagram of displaying a rescue request according to an exemplary embodiment of this application. As shown in FIG. 12, a rescue request sent by a virtual object A that is injured and falls to the ground is displayed, and includes an avatar frame 1201 of the virtual object A and a distance 1202 between the virtual object A and a virtual object B mainly controlled by a current terminal.

The rescue request is displayed in a form of a pop-up window, and highlighted to present, to the player, a current to-be-rescued state of the first virtual object, to prevent the player from omitting information that a teammate needs to be rescued, thereby improving the rescue efficiency.

Operation 1120: Display rescue guidance in response to that a second virtual character mainly controlled by a current terminal accepts a rescue request.

The rescue guidance is configured for indicating an orientation relationship between the first virtual character and the second virtual character.

In some embodiments, the rescue guidance is implemented as a rescue indicator line in a virtual map, or the rescue guidance is implemented as a virtual guidance icon in a virtual scene. The virtual map is a map picture superimposed to be displayed in a display picture, and is configured for indicating a position of the second virtual object in the virtual scene. In some embodiment, the virtual map may be implemented as a map thumbnail picture of a virtual scene region in which the second virtual object is located. That is, the virtual map is a map picture in which a virtual scene map is zoomed out according to a specified proportion and displays the region in which the second virtual object is located. In some embodiments, the virtual map includes a first positioning identifier corresponding to the first virtual object, and a second positioning identifier corresponding to the second virtual object. The first positioning identifier and the second positioning identifier are configured for indicating a position relationship between the first virtual object and the second virtual object. The rescue indicator line is an indicator line connected between the first positioning identifier and the second positioning identifier, and is configured for representing rescue willingness of the second virtual object for the first virtual object. The virtual guide icon in the virtual scene is an icon that follows the viewing angle of the second virtual object and that directs an orientation of the first virtual object to the second virtual object in the virtual scene.

In some embodiments, a case in which the rescue guidance is displayed includes at least one of the following:
Case 1: In response to a calibration operation performed by the second virtual object on the first virtual object when the second virtual object does not accept the rescue request, the rescue guidance is displayed.

The calibration operation performed by the second virtual object on the first virtual object is configured for representing active rescue willingness of the second virtual object for the first virtual object.
Case 2: In response to that the second virtual object moves to the first virtual object at a movement speed exceeding a speed threshold when the second virtual object does not accept the rescue request, the rescue guidance is displayed.

The second virtual object moving to the first virtual object at the movement speed exceeding the speed threshold indicates that the second virtual object may have rescue willingness for the first virtual object.

In summary, according to the method provided in this embodiment of this application, a rescue request transmitted by a first virtual object in a virtual scene is displayed, where the rescue request including an identity and position information of the first virtual object, so that a second virtual object can learn the rescue request in a timely and clear manner, to determine whether to go for rescue. A rescue guidance is displayed in response to that the second virtual character mainly controlled by a current terminal accepts the rescue request, to assist in rescue, thereby improving rescue efficiency and utilization of rescue resources.

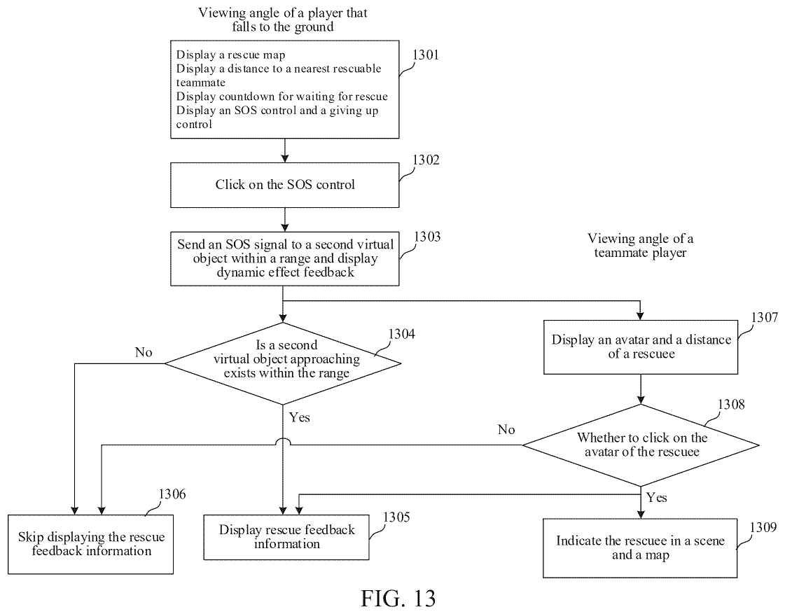

FIG. 13 is a schematic flowchart of a viewing angle of a player that falls to the ground and a viewing angle of a teammate player according to an exemplary embodiment of this application. As shown in FIG. 13, from the viewing angle of the player that falls to the ground, the following operations are included:

Operation 1301: Display a rescue map, a distance to a nearest rescuable teammate, countdown for waiting for rescue, and an SOS control and a giving up control.

The rescue map is displayed, and a first positioning identifier, in the rescue map, of the first virtual object corresponding to the player that falls to the ground, and a second positioning identifier, in the rescue map, of the second virtual object corresponding to the teammate player are displayed in the rescue map. The rescue map is implemented as a topographic thumbnail of the virtual scene.

The distance to the nearest rescuable teammate is displayed, that is, a distance between a nearest second virtual object currently in the virtual scene and the first virtual object, to determine a capability of the nearest second virtual object to move to the position of the first virtual object to rescue the first virtual object.

The countdown for waiting for rescue is displayed, and the countdown for waiting for rescue is configured for indicating remaining duration for which the first virtual object remains in a virtual battle in a falling-to-ground state. When the countdown for waiting for rescue ends, the first virtual object needs to be forced to end the virtual battle, or the first virtual object is forced to watch the virtual battle as an identity of a bystander. Alternatively, the first virtual object needs to continue a virtual battle by using an additional means, for example, a capability of reviving in a virtual battle through resource redemption.

The SOS control and the giving up control are displayed, and the SOS control is configured to initiate SOS to the second virtual object, and request the second virtual object to provide rescue to the first virtual object. The giving up control is configured to indicate the player that falls to the ground to give up rescue from the second virtual object, and actively exit the virtual battle.

Operation 1302: Click on the SOS control.

The SOS control is clicked on, which represents that the player that falls to the ground requests to send a rescue request to the second virtual object, to request the second virtual object to provide rescue assistance to the first virtual object that falls to the ground. In some embodiments, after the SOS control is clicked on, a cool down state (a forbidden state) is entered, and the SOS control may be clicked on again after preset duration. The preset duration may be configured in a plan manner. For example, the cool down duration is 15 s.

Operation 1303: Send an SOS signal to the second virtual object within a range and display dynamic effect feedback.

In some embodiments, the dynamic effect feedback of the SOS signal is displayed in the rescue map. For example, a dynamic circle is diffused and displayed by using the first positioning identifier of the first virtual object as a center, and the second virtual object within the range receives a prompt.

Operation 1304: Determine whether a second virtual object approaching exists within the range.

It is determined whether a second virtual object approaching at a first speed exists within the range. The first speed is a speed at which the second virtual object approaches the first virtual object at a fast walking or running pose, or the first speed is a speed exceeding a preset speed threshold.

Operation 1305. Display rescue feedback information if the second virtual object approaching exists.

If the second virtual object selects to rescue the player that falls to the ground, the first rescue indicator line is displayed, and if the second virtual object quickly approaching the first virtual object exists, the second rescue indicator line is displayed. The first rescue indicator line is implemented as a guide line having a direction, for example, a guide line pointing from the second virtual object to the first virtual object. The second rescue indicator line is implemented as a dashed line. In some embodiments, the second rescue indicator line corresponds to first transparency.

Operation 1306: Skip displaying the rescue feedback information if the second virtual object approaching does not exist.

From a viewing angle of the teammate player, the following operations are included:

Operation 1307: Display an avatar and a distance of the rescuee.

After the foregoing operation 1303, if the second virtual object is within a rescue range of the first virtual object, an avatar of the first virtual object and a distance between the avatar of the first virtual object and the first virtual object are displayed. The teammate player can determine, based on the avatar and the distance, whether to provide rescue for the first virtual object.

Operation 1308: Determine whether to click on the avatar of the rescuee.

When a click operation on the avatar of the rescuee is received, the teammate player responds to the rescue request of the first virtual object, and provides rescue for the first virtual object.

Operation 1309: Indicate the rescuee in a scene and a map if the avatar of the rescuee is clicked on.

In some embodiments, a direction guidance element is displayed in the virtual scene, and the direction guidance element is configured for indicating, to the second virtual object, an orientation of the first virtual object in the virtual scene. An indicator line is displayed in the rescue map, and the indicator line is configured for indicating a current position relationship between the first virtual object and the second virtual object.

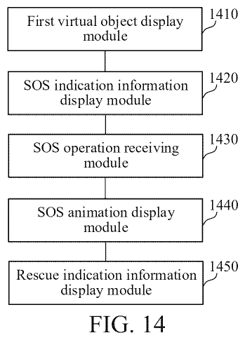

FIG. 14 is a structural block diagram of an interaction apparatus in a virtual scene according to an exemplary embodiment of this application. As shown in FIG. 14, the apparatus includes the following parts:
a first virtual object display module 1410, configured to display a first virtual object in the virtual scene, the first virtual object being a virtual object mainly controlled by a current terminal, and the virtual scene further including a second virtual object;
an SOS indication information display module 1420, configured to display SOS indication information when the first virtual object is in a restricted action state, the SOS indication information being configured for indicating the first virtual object to initiate a rescue request, and the restricted action state being a state in which an action capability of the first virtual object is restricted in the virtual scene;
an SOS operation receiving module 1430, configured to receive an SOS operation;
an SOS animation display module 1440, configured to display an SOS animation in response to receiving the SOS operation, the SOS animation being configured for representing that the first virtual object transmits the rescue request to the second virtual object; and
a rescue indication information display module 1450, configured to display rescue indication information in response to that the second virtual object performs feedback to the rescue request, the rescue indication information being configured for indicating the second virtual object to accept the rescue request for rescuing the first virtual object.

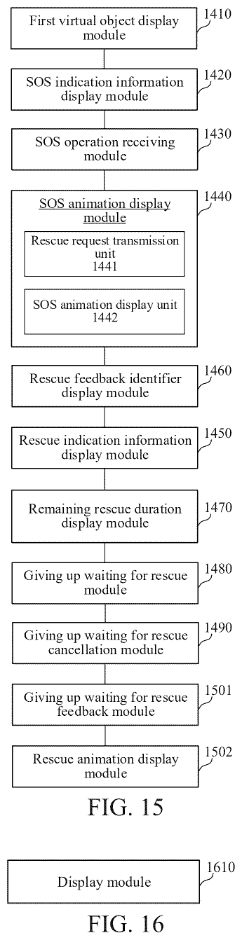

FIG. 15 is a structural block diagram of an interaction apparatus module according to an exemplary embodiment of this application. As shown in FIG. 15, in some embodiments, the SOS animation display module 1440 includes:
a rescue request transmission unit 1441, configured to transmit the rescue request to the second virtual object in response to receiving the SOS operation; and
an SOS animation display unit 1442, configured to display the SOS animation in a virtual map, the virtual map including a first positioning identifier corresponding to the first virtual object, and a second positioning identifier corresponding to the second virtual object, the first positioning identifier and the second positioning identifier being configured for indicating positions of the first virtual object and the second virtual object in the virtual scene, and the SOS animation including an animation in which the first positioning identifier transmits the rescue request to the second positioning identifier.

In some embodiments, the SOS animation display unit 1442 is configured to display an animation effect of diffusing from a first arc to a second arc in the virtual map, the first arc and the second arc being arcs using the first positioning identifier as a center, and a radius of the first arc being less than a radius of the second arc.

In some embodiments, the apparatus further includes a request delivery identifier display module 1460, configured to: display, in the virtual map when the second positioning identifier and the second arc conform to a position relationship, a request delivery identifier corresponding to the second positioning identifier, the request delivery identifier being configured for representing that the rescue request is displayed to the second virtual object.

In some embodiments, the rescue indication information display module 1450 is configured to: display, in the virtual map in response to that the second virtual object accepts the rescue request, a first rescue indicator line connected between the first positioning identifier and the second positioning identifier; or display the first rescue indicator line in the virtual map in response to that the second virtual object calibrates the first positioning identifier in the virtual map; or display, in the virtual map, a second rescue indicator line connected between the first positioning identifier and the second positioning identifier in response to that the second virtual object moves to the first virtual object at a movement speed exceeding a speed threshold, where a display priority of the first rescue indicator line is higher than a display priority of the second rescue indicator line.

In some embodiments, the apparatus further includes:
a remaining rescue duration display module 1470, configured to display remaining rescue duration when the first virtual object is in the restricted action state, the remaining rescue duration being configured for indicating remaining duration for which the first virtual object can perform rescue by using the second virtual object to release the restricted action state, and the remaining rescue duration being reduced at a first speed; and
a giving up waiting for rescue module 1480, configured to display that the remaining rescue duration is reduced at a second speed in response to receiving an operation of giving up waiting for rescue from the first virtual object, the second speed being greater than the first speed.

In some embodiments, the apparatus further includes a giving up waiting for rescue cancellation module 1490, configured to restore the remaining rescue duration to be reduced at the first speed in response to receiving an operation of canceling giving up waiting for rescue from the first virtual object.

In some embodiments, the apparatus further includes a giving up waiting for rescue feedback module 1501, configured to display rescue prompt information in response to receiving the operation of giving up waiting for rescue from the first virtual object when the rescue duration is less than the remaining rescue duration, the rescue prompt information being configured for prompting the first virtual object that the rescue duration is less than the remaining duration, and the rescue duration being configured for indicating duration required by the second virtual object to reach a position of the first virtual object at the specified speed; or play an out-of-game preview animation in response to receiving the operation of giving up waiting for rescue, the out-of-game preview animation including an animation in which the first virtual object converts from the restricted action state into an out-of-game state, and the out-of-game state being a state in which the first virtual object ends a virtual battle.

In some embodiments, the apparatus further includes a rescue animation display module 1502, configured to: play, in response to that the second virtual object performs feedback to the rescue request, an animation in which the second virtual object moves to the first virtual object; or play, in response to that the second virtual object conforms to a rescue success condition, an animation in which the second virtual object moves to the first virtual object; or play a rescue success preview animation in response to that the second virtual object conforms to a rescue success condition, the rescue success preview animation including an animation in which the first virtual object converts from the restricted action state into a normal action state, and the normal action state being a state in which the action capability of the first virtual object is not restricted in the virtual scene, where the rescue success condition includes that the rescue distance is less than a distance threshold, or the rescue duration is less than a duration threshold, the rescue distance is configured for indicating the distance between the second virtual object and the first virtual object in the virtual scene, and the rescue duration is configured for indicating the duration required by the second virtual object to reach the position of the first virtual object at the specified speed.

In summary, according to the apparatus provided in this embodiment of this application, when the first virtual object is in the restricted action state, the SOS indication information is displayed, the SOS animation is displayed in response to receiving the SOS operation, and the rescue indication information is displayed in response to that the second virtual object performs feedback to the rescue request. The rescue willingness of the first virtual object is strengthened by using the SOS indication information, feedback is performed in time to the SOS operation of the first virtual character by using the SOS animation, and the first virtual object is notified of the rescue willingness of the second virtual object by using the rescue indication information, thereby implementing a feedback mechanism between SOS and rescue, enhancing willingness to wait for rescue, and improving rescue efficiency. Therefore, utilization of rescue resources is improved.

FIG. 16 is a schematic diagram of an interaction apparatus in a virtual scene according to another exemplary embodiment of this application. The apparatus includes:
a display module 1610, configured to display a rescue request transmitted by a first virtual object in a virtual scene, the rescue request being a request transmitted by the first virtual object by using an SOS operation when the first virtual object is in a restricted action state, the rescue request including an identity and position information of the first virtual object, and the restricted action state being a state in which an action capability of the first virtual object is restricted in the virtual scene; and display rescue guidance in response to that a second virtual object mainly controlled by a current terminal accepts the rescue request, the rescue guidance being configured for indicating an orientation relationship between the first virtual character and the second virtual object.

In an exemplary embodiment, the display module 1610 is further configured to display the rescue guidance in response to a calibration operation performed by the second virtual object on the first virtual object when the second virtual object does not accept the rescue request; or the display module 1610 is further configured to display the rescue guidance in response to that the second virtual object moves to the first virtual object at a movement speed exceeding a speed threshold when the second virtual object does not accept the rescue request.

The interaction apparatus in a virtual scene provided in the foregoing embodiments is merely illustrated with an example of division of each functional module. In actual application, the functions may be allocated to and completed by different functional modules according to requirements, that is, an internal structure of the device is divided into different functional modules, to implement all or some of the functions described above.

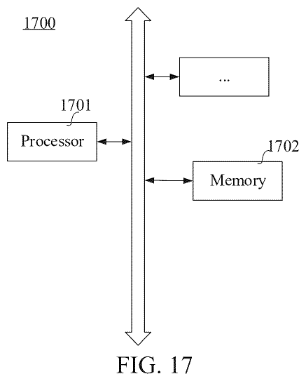

FIG. 17 is a structural block diagram of a terminal 1700 according to an exemplary embodiment of this application. The terminal 1700 may be: a smartphone, a tablet computer, a Moving Picture Experts Group Audio Layer III (MP3) player, a Moving Picture Experts Group Audio Layer IV (MP4) player, a notebook computer, or a desktop computer. The terminal 1700 may also be referred to as other names such as user equipment, a portable terminal, a laptop terminal, or a desktop terminal.

Generally, the terminal 1700 includes: a processor 1701 and a memory 1702.

The processor 1701 may include one or more processing cores, such as a 4-core processor or an 8-core processor. The processor 1701 may be implemented by using at least one hardware form of a digital signal processing (DSP), a field-programmable gate array (FPGA), and a programmable logic array (PLA). The processor 1701 includes a main processor and a coprocessor. The main processor is configured to process data in an active state, also referred to as a central processing unit (CPU). The coprocessor is a low-power consumption processor configured to process data in a standby state. In some embodiments, the processor 1701 may be integrated with a graphics processing unit (GPU). The GPU is configured to be responsible for rendering and drawing content that needs to be displayed in a display. In some embodiments, the processor 1701 may alternatively include an artificial intelligence (AI) processor. The AI processor is configured to process a computing operation related to machine learning.

The memory 1702 may include one or more non-transitory computer-readable storage media. The computer-readable storage media may be non-transitory. The memory 1702 may further include a high-speed random access memory and a non-volatile memory, such as one or more disk storage devices and flash storage devices. In some embodiments, the non-transitory computer-readable storage medium in the memory 1702 is configured to store at least one instruction. The at least one instruction is executed by the processor 1701 to perform the interaction method in a virtual scene provided in the method embodiment in this application.

In some embodiments, the terminal 1700 further include another component. A person skilled in the art may understand that the structure shown in FIG. 17 does not constitute a limitation to the terminal 1700, and the terminal 1700 may include more or fewer components than those shown in the figure, or some components may be combined, or a different component deployment may be used.

An embodiment of this application further provides a computer device. The computer device may be implemented as the terminal or the server shown in FIG. 2. The computer device includes a processor and a memory. The memory has at least one instruction, at least one program, a code set or an instruction set stored therein, the at least one instruction, the at least one program, the code set or the instruction set being loaded and executed by a processor to implement the interaction method in a virtual scene according to the foregoing method embodiments.

An embodiment of this application further provides a non-transitory computer-readable storage medium. The computer-readable storage medium has at least one instruction, at least one program, a code set or an instruction set stored therein, the at least one instruction, the at least one program, the code set or the instruction set being loaded and executed by the processor to implement the interaction method in a virtual scene according to the foregoing method embodiments.

An embodiment of this application further provides a computer program product or a computer program. The computer program product or the computer program includes computer instructions, the computer instructions being stored in a computer-readable storage medium. A processor of a computer device reads the computer instructions from the computer-readable storage medium and executes the computer instructions to cause the computer device to perform the interaction method in a virtual scene according to any one of the foregoing embodiments.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit.

What is claimed is:

1. An interaction method performed by a computer device, the method comprising:
displaying a virtual scene including a first virtual object and a second object, the first virtual object being a virtual object controlled by a user of the computer device;
displaying SOS indication information when the first virtual object is in a restricted action state, the restricted action state being a state in which an action capability of the first virtual object is restricted in the virtual scene;
displaying an SOS animation in response to receiving an SOS operation, the SOS animation being configured for representing that the first virtual object transmits a rescue request to the second virtual object; and
displaying rescue indication information in response to that the second virtual object performs feedback to the rescue request, the rescue indication information being configured for indicating the second virtual object to accept the rescue request for rescuing the first virtual object.

2. The method according to claim 1, wherein the displaying an SOS animation in response to receiving an SOS operation comprises:
transmitting the rescue request to the second virtual object in response to receiving the SOS operation; and
displaying the SOS animation in a virtual map, the virtual map comprising a first positioning identifier corresponding to the first virtual object, and a second positioning identifier corresponding to the second virtual object, the first positioning identifier and the second positioning identifier being configured for indicating positions of the first virtual object and the second virtual object in the virtual scene, and the SOS animation comprising an animation in which the first positioning identifier transmits the rescue request to the second positioning identifier.

3. The method according to claim 2, wherein the displaying the SOS animation in a virtual map comprises:
displaying an animation effect of diffusing from a first arc to a second arc in the virtual map, the first arc and the second arc being arcs using the first positioning identifier as a center, and a radius of the first arc being less than a radius of the second arc.

4. The method according to claim 1, wherein the rescue indication information comprises at least one of the following:
an identity of the second virtual object;
a rescue distance, configured for indicating a distance between the second virtual object and the first virtual object in the virtual scene;
rescue duration, configured for indicating duration required by the second virtual object to reach the position of the first virtual object at a specified speed; or
a rescue indicator line, configured for representing a degree of willingness tendency of the second virtual object to rescue the first virtual object.

5. The method according to claim 1, wherein the method further comprises:
displaying remaining rescue duration when the first virtual object is in the restricted action state, the remaining rescue duration being configured for indicating remaining duration for which the first virtual object can perform rescue by using the second virtual object to release the restricted action state, and the remaining rescue duration being reduced at a first speed; and
displaying that the remaining rescue duration is reduced at a second speed in response to receiving an operation of giving up waiting for rescue from the first virtual object, the second speed being greater than the first speed.

6. The method according to claim 1, wherein the method further comprises:
playing, in response to that the second virtual object performs feedback to the rescue request, an animation in which the second virtual object moves to the first virtual object; or
playing, in response to that the second virtual object conforms to a rescue success condition, an animation in which the second virtual object moves to the first virtual object; or
playing a rescue success preview animation in response to that the second virtual object conforms to a rescue success condition, the rescue success preview animation comprising an animation in which the first virtual object switches from the restricted action state into a normal action state, and the normal action state being a state in which the action capability of the first virtual object is not restricted in the virtual scene, wherein
the rescue success condition comprises that the rescue distance is less than a distance threshold, or the rescue duration is less than a duration threshold, the rescue distance is configured for indicating the distance between the second virtual object and the first virtual object in the virtual scene, and the rescue duration is configured for indicating the duration required by the second virtual object to reach the position of the first virtual object at the specified speed.

7. The method according to claim 1, wherein the SOS indication information comprises at least one of the following:
an SOS control, configured to receive the SOS operation;
an SOS-capable object identifier, configured for indicating a second virtual object conforming to a rescue condition; and
a minimum rescue distance, configured for indicating a minimum distance between a plurality of second virtual objects conforming to the rescue condition and the first virtual object, wherein
the rescue condition comprises that the distance between the second virtual object and the first virtual object is less than a rescue distance threshold, or the second virtual object and the first virtual object are in the same camp, or the second virtual object conforms to a specified virtual character identity.

8. A computer device, comprising a processor and a memory, the memory having at least one program stored therein, the at least one program being loaded and executed by the processor to cause the computer device to implement an interaction method in a virtual scene including:
displaying a virtual scene including a first virtual object and a second object, the first virtual object being a virtual object controlled by a user of the computer device;
displaying SOS indication information when the first virtual object is in a restricted action state, the restricted action state being a state in which an action capability of the first virtual object is restricted in the virtual scene;
displaying an SOS animation in response to receiving an SOS operation, the SOS animation being configured for representing that the first virtual object transmits a rescue request to the second virtual object; and
displaying rescue indication information in response to that the second virtual object performs feedback to the rescue request, the rescue indication information being configured for indicating the second virtual object to accept the rescue request for rescuing the first virtual object.

9. The computer device according to claim 8, wherein the displaying an SOS animation in response to receiving an SOS operation comprises:
transmitting the rescue request to the second virtual object in response to receiving the SOS operation; and
displaying the SOS animation in a virtual map, the virtual map comprising a first positioning identifier corresponding to the first virtual object, and a second positioning identifier corresponding to the second virtual object, the first positioning identifier and the second positioning identifier being configured for indicating positions of the first virtual object and the second virtual object in the virtual scene, and the SOS animation comprising an animation in which the first positioning identifier transmits the rescue request to the second positioning identifier.

10. The computer device according to claim 9, wherein the displaying the SOS animation in a virtual map comprises:
displaying an animation effect of diffusing from a first arc to a second arc in the virtual map, the first arc and the second arc being arcs using the first positioning identifier as a center, and a radius of the first arc being less than a radius of the second arc.

11. The computer device according to claim 8, wherein the rescue indication information comprises at least one of the following:
an identity of the second virtual object;
a rescue distance, configured for indicating a distance between the second virtual object and the first virtual object in the virtual scene;
rescue duration, configured for indicating duration required by the second virtual object to reach the position of the first virtual object at a specified speed; or
a rescue indicator line, configured for representing a degree of willingness tendency of the second virtual object to rescue the first virtual object.

12. The computer device according to claim 8, wherein the method further comprises:
displaying remaining rescue duration when the first virtual object is in the restricted action state, the remaining rescue duration being configured for indicating remaining duration for which the first virtual object can perform rescue by using the second virtual object to release the restricted action state, and the remaining rescue duration being reduced at a first speed; and
displaying that the remaining rescue duration is reduced at a second speed in response to receiving an operation of giving up waiting for rescue from the first virtual object, the second speed being greater than the first speed.

13. The computer device according to claim 8, wherein the method further comprises:
playing, in response to that the second virtual object performs feedback to the rescue request, an animation in which the second virtual object moves to the first virtual object; or
playing, in response to that the second virtual object conforms to a rescue success condition, an animation in which the second virtual object moves to the first virtual object; or
playing a rescue success preview animation in response to that the second virtual object conforms to a rescue success condition, the rescue success preview animation comprising an animation in which the first virtual object switches from the restricted action state into a normal action state, and the normal action state being a state in which the action capability of the first virtual object is not restricted in the virtual scene, wherein
the rescue success condition comprises that the rescue distance is less than a distance threshold, or the rescue duration is less than a duration threshold, the rescue distance is configured for indicating the distance between the second virtual object and the first virtual object in the virtual scene, and the rescue duration is configured for indicating the duration required by the second virtual object to reach the position of the first virtual object at the specified speed.

14. The computer device according to claim 8, wherein the SOS indication information comprises at least one of the following:
an SOS control, configured to receive the SOS operation;
an SOS-capable object identifier, configured for indicating a second virtual object conforming to a rescue condition; and
a minimum rescue distance, configured for indicating a minimum distance between a plurality of second virtual objects conforming to the rescue condition and the first virtual object, wherein
the rescue condition comprises that the distance between the second virtual object and the first virtual object is less than a rescue distance threshold, or the second virtual object and the first virtual object are in the same camp, or the second virtual object conforms to a specified virtual character identity.

15. A non-transitory computer-readable storage medium having at least one program stored therein, the at least one program being loaded and executed by a processor of a computer device to cause the computer device to implement an interaction method in a virtual scene including:
displaying a virtual scene including a first virtual object and a second object, the first virtual object being a virtual object controlled by a user of the computer device;
displaying SOS indication information when the first virtual object is in a restricted action state, the restricted action state being a state in which an action capability of the first virtual object is restricted in the virtual scene;
displaying an SOS animation in response to receiving an SOS operation, the SOS animation being configured for representing that the first virtual object transmits a rescue request to the second virtual object; and
displaying rescue indication information in response to that the second virtual object performs feedback to the rescue request, the rescue indication information being configured for indicating the second virtual object to accept the rescue request for rescuing the first virtual object.

16. The non-transitory computer-readable storage medium according to claim 15, wherein the displaying an SOS animation in response to receiving an SOS operation comprises:
transmitting the rescue request to the second virtual object in response to receiving the SOS operation; and
displaying the SOS animation in a virtual map, the virtual map comprising a first positioning identifier corresponding to the first virtual object, and a second positioning identifier corresponding to the second virtual object, the first positioning identifier and the second positioning identifier being configured for indicating positions of the first virtual object and the second virtual object in the virtual scene, and the SOS animation comprising an animation in which the first positioning identifier transmits the rescue request to the second positioning identifier.

17. The non-transitory computer-readable storage medium according to claim 16, wherein the displaying the SOS animation in a virtual map comprises:
displaying an animation effect of diffusing from a first arc to a second arc in the virtual map, the first arc and the second arc being arcs using the first positioning identifier as a center, and a radius of the first arc being less than a radius of the second arc.

18. The non-transitory computer-readable storage medium according to claim 15, wherein the rescue indication information comprises at least one of the following:
an identity of the second virtual object;
a rescue distance, configured for indicating a distance between the second virtual object and the first virtual object in the virtual scene;
rescue duration, configured for indicating duration required by the second virtual object to reach the position of the first virtual object at a specified speed; or
a rescue indicator line, configured for representing a degree of willingness tendency of the second virtual object to rescue the first virtual object.

19. The non-transitory computer-readable storage medium according to claim 15, wherein the method further comprises:
displaying remaining rescue duration when the first virtual object is in the restricted action state, the remaining rescue duration being configured for indicating remaining duration for which the first virtual object can perform rescue by using the second virtual object to release the restricted action state, and the remaining rescue duration being reduced at a first speed; and
displaying that the remaining rescue duration is reduced at a second speed in response to receiving an operation of giving up waiting for rescue from the first virtual object, the second speed being greater than the first speed.

20. The non-transitory computer-readable storage medium according to claim 15, wherein the method further comprises:
playing, in response to that the second virtual object performs feedback to the rescue request, an animation in which the second virtual object moves to the first virtual object; or
playing, in response to that the second virtual object conforms to a rescue success condition, an animation in which the second virtual object moves to the first virtual object; or
playing a rescue success preview animation in response to that the second virtual object conforms to a rescue success condition, the rescue success preview animation comprising an animation in which the first virtual object switches from the restricted action state into a normal action state, and the normal action state being a state in which the action capability of the first virtual object is not restricted in the virtual scene, wherein
the rescue success condition comprises that the rescue distance is less than a distance threshold, or the rescue duration is less than a duration threshold, the rescue distance is configured for indicating the distance between the second virtual object and the first virtual object in the virtual scene, and the rescue duration is configured for indicating the duration required by the second virtual object to reach the position of the first virtual object at the specified speed.
